(19) United States
(12) Patent Application Publication
(10) Pub. No.: US 2024/0017342 A1
(43) Pub. Date: Jan. 18, 2024

(54) WELDING TECHNIQUE MONITORING SYSTEMS USING ACOUSTIC TRACKING

(71) Applicant: Illinois Tool Works Inc., Glenview, IL (US)

(72) Inventor: William Joshua Becker, Neenah, WI (US)

(21) Appl. No.: 18/219,937

(22) Filed: Jul. 10, 2023

Related U.S. Application Data
(60) Provisional application No. 63/390,133, filed on Jul. 18, 2022.

(51) Int. Cl. B23K 9/127

(52) U.S. Cl. CPC B23K 9/127; B23K 20/123

(57) ABSTRACT

Disclosed example weld tracking system include a plurality of tracking anchors, each of the tracking anchors configured to: transmit a triggering signal, and transmit a response signal, or receive a response signal from a tracking tag; a welding device having the tracking tag attached to the welding device, the tracking tag configured to receive the triggering signal and receive the response signal, or receive the triggering signal and transmit the response signal in response to receiving the triggering signal; and a processing system configured to determine a distance between the tracking anchor and the tracking tag based on a time between the response signal being received and the triggering signal being sent or received, and determine a location of the welding device based on predetermined locations of the plurality of tracking anchors, and based on determined distances between the at least one tracking tag on the welding device and corresponding ones of the plurality of tracking anchors.

### CROSS REFERENCE TO RELATED APPLICATIONS

The present application claims priority to, and the benefit of, U.S. Provisional Application No. 63/390,133, entitled “Systems and Methods to Track Welding Equipment,” filed Jul. 18, 2022, the entire contents of which are hereby incorporated by reference.

### TECHNICAL FIELD

The present disclosure generally relates to welding technique monitoring systems, and, more particularly, to welding technique monitoring systems using acoustic tracking.

### BACKGROUND

Welding technique generally refers to the way in which a welding operator positions, moves, and/or manipulates a welding-type tool relative to a workpiece (and/or a welding joint of the workpiece), such as, for example, during a welding-type operation. Good welding technique can positively impact the quality of a weld. Bad welding technique can negatively impact the quality of a weld. However, it can sometimes be difficult for (e.g., less experienced) human operators to accurately judge whether welding technique is good or bad.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to welding technique monitoring systems using acoustic tracking, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 shows an example of a welding system, in accordance with aspects of this disclosure.

FIG. 2 illustrates an example arrangement of tracking anchors and tracking tags that might be used by a tracking system to track objects and/or persons of the welding system of FIG. 1, in accordance with aspects of this disclosure.

FIG. 3 is a block diagram showing an example welding technique monitoring system comprising the example tracking anchors, tracking tags, and tracking system of FIG. 2, in accordance with aspects of this disclosure.

FIG. 4 is a flow diagram illustrating an example monitoring process of the example welding technique monitoring system of FIG. 3, in accordance with aspects of this disclosure.

The figures are not necessarily to scale. Where appropriate, the same or similar reference numerals are used in the figures to refer to similar or identical elements. For example, reference numerals utilizing lettering (e.g., workpiece 122a, workpiece 122b) refer to instances of the same reference numeral that does not have the lettering (e.g., workpieces 122).

### DETAILED DESCRIPTION

Some examples of the present disclosure relate to a weld tracking system, comprising: a plurality of tracking anchors, each of the tracking anchors configured to: transmit a triggering signal, and transmit a response signal, or receive the response signal from a tracking tag; a welding device having the tracking tag attached to the welding device, the tracking tag configured to receive the triggering signal and receive the response signal, or receive the triggering signal and transmit the response signal in response to receiving the triggering signal; and a processing system configured to: determine distances between each of the tracking anchors and the tracking tag based on a time between the response signal being received and the triggering signal being sent or received, and determine a location of the welding device based on predetermined locations of the plurality of tracking anchors, and based on determined distances between the tracking tag on the welding device and corresponding ones of the plurality of tracking anchors.

In some examples, the processing system is configured to determine positions of the plurality of tracking anchors based on a predetermined spatial relationship between the plurality of tracking anchors and based on a calibration process to determine positions of two or more of the plurality of tracking anchors in the predetermined spatial relationship with respect to a reference location. In some examples, the welding device is at least one of a welding torch, a welding helmet, safety glasses, or a welding fixture. In some examples, the processing system is configured to determine the location of the welding device with respect to the reference location based on the positions of the plurality of tracking anchors.

In some examples, the triggering signal is an electromagnetic signal and the response signal is an acoustic signal. In some examples, the triggering signal is a radiofrequency signal. In some examples, the triggering signal is an ultrasonic signal.

In some examples, the welding device has a plurality of tracking tags attached to the welding device, and the processing system is configured to determine the location of the welding device based on measuring the locations of the plurality of tracking tags. In some examples, the processing system is configured to determine an orientation of the welding device based on measuring the locations of the plurality of tracking tags on the welding device and based on a rigid body model of the welding device and the plurality of tracking tags on the welding device. In some examples, the welding device is a welding torch, and the processing system is configured to determine a welding performance based on a plurality of locations of the welding device during a welding operation.

In some examples, the tracking tag or each of the tracking anchors is configured to transmit the response signal as an ultrasonic signal having a frequency selected to avoid interference from welding-based noise. In some examples, the weld tracking system further comprises a noise monitor configured to measure ultrasonic frequencies in an environment proximate to the tracking anchors and the tracking tag, and configured to transmit feedback representative of at least one of a preferred ultrasonic channel or ultrasonic frequency or a non-preferred ultrasonic channel or ultrasonic frequency. In some examples, the plurality of tracking anchors are configured to transmit the triggering signal having data representative of the at least one of a preferred ultrasonic channel or ultrasonic frequency or a non-preferred ultrasonic channel or ultrasonic frequency, and the tracking tag is configured to select an ultrasonic channel to transmit the response signal based on the data in the triggering signal.

In some examples, the tracking tag or each of the tracking anchors is configured to receive the feedback from the noise monitor and select an ultrasonic channel to transmit the response signal based on the feedback. In some examples, the tracking tag or each of the tracking anchors is configured to select an ultrasonic channel to transmit the response signal based on a table having ultrasonic frequency data associated with at least one of a welding parameter or a welding process. In some examples, the plurality of tracking anchors are configured to: determine, based on a table having ultrasonic frequency data associated with at least one of a welding parameter or a welding process, at least one of a preferred ultrasonic channel or ultrasonic frequency or a non-preferred ultrasonic channel or ultrasonic frequency; and transmit the triggering signal having data representative of the at least one of a preferred ultrasonic channel or ultrasonic frequency or a non-preferred ultrasonic channel or ultrasonic frequency, and the tracking tag is configured to select an ultrasonic channel to transmit the response signal based on the data in the triggering signal.

In some examples, the welding device comprises: three or more tracking tags spatially separated in a fixed rigid configuration; two spatially separated tracking tags rigidly connected to each other, each of the tracking tags comprising an accelerometer configured to measure the angle of the tracking tag relative to gravity; or a single tracking tag having an accelerometer and a gyroscope, wherein the processing system is configured to determine a six-degree-of-freedom location and orientation of the welding device based on the three or more tracking tags, the two tracking tags, or the one tracking tag. In some examples, the plurality of tracking anchors are affixed to one or more rigid structures defining a rigid spatial relationship between the ones of the tracking anchors affixed to the respective rigid structure. In some examples, the rigid structures are portable. In some examples, the processing system is configured to determine, based on the location of the welding device and a rigid body model of the tracking tag and the welding device, at least one of a work angle, a travel angle, a travel direction, a travel speed, or a contact tip to work distance of a welding torch during a live welding operation or a simulated welding operation.

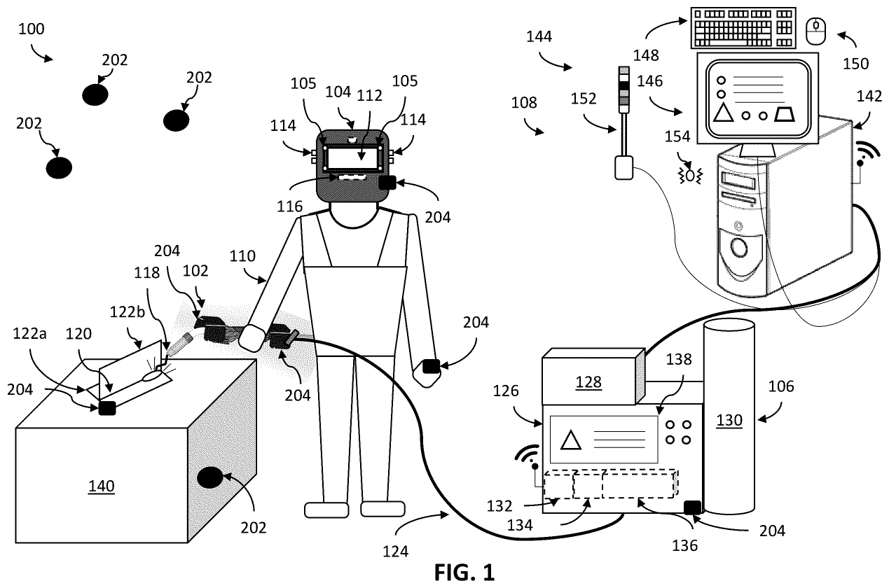

FIG. 1 shows an example welding system 100. As shown, the welding system 100 includes a welding-type tool 102, welding helmet 104, welding equipment 106, and computing system 108.

While shown as a welding torch or gun configured for gas metal arc welding (GMAW) in the example of FIG. 1, in some examples, the welding-type tool 102 may instead be a different kind of welding-type tool 102. For example, the welding-type tool 102 may be an electrode holder (i.e., stinger) configured for shielded metal arc welding (SMAW), a torch and/or filler rod configured for gas tungsten arc welding (GTAW), a welding gun configured for flux-cored arc welding (FCAW), and/or a plasma cutter. While shown as a live welding-type tool 102 in the example of FIG. 1, in some examples, the welding-type tool 102 may be a mock welding-type tool, and/or be configured for mock (as opposed to live) welding-type operations, such as for (e.g., virtual/augmented reality) weld training.

In the example of FIG. 1, the welding-type tool 102 is shown being held by an operator 110 wearing the welding helmet 104. In the example of FIG. 1, the welding helmet 104 includes a helmet shell, helmet display screen 112, helmet user interface (UI) devices 114, helmet sensors 105, and helmet circuitry 116. In some examples, the helmet UI devices 114 may include knobs, buttons, levers, switches, touch screens, microphones, speakers, haptic devices, lights (e.g., LEDs), eye trackers, and/or other appropriate helmet UI devices 114. In some examples, the helmet display screen 112 may be considered part of the helmet UI devices 114.

In some examples, the helmet sensors 105 may include optical, camera, infra-red, heat, ultrasonic, electromagnetic, and/or other appropriate sensors. In some examples, the helmet sensors 105 may be used to determine whether a (e.g., live) welding-type operation is taking place (e.g., via measurement of accompanying light, heat, sound, electromagnetic fields, etc.). While shown on the outside of the welding helmet 104 in the example of FIG. 1, in some examples, one or more of the helmet UI devices 114 and/or helmet sensors 105 may be positioned within the welding helmet 102. In some examples, the helmet UI devices 114 and/or helmet sensors 105 may be electrical communication with the helmet circuitry 116.

In some examples, the helmet circuitry 116 may include helmet processing circuitry, helmet memory circuitry, helmet UI circuitry, and/or helmet communication circuitry. In some examples, the helmet UI circuitry may drive the helmet UI devices 114. In some examples, the welding helmet 104 may communicate with one or more external devices via one or more signals sent or received by the helmet communication circuitry. While shown as a helmet in the example of FIG. 1, in some examples, the welding helmet 104 may alternatively, or additionally, comprise welding safety glasses.

In the example of FIG. 1, the welding-type tool 102 is shown applying a welding arc 118 to a joint 120 between two workpieces 122 (e.g., to weld the workpieces 122 together at the joint 120). As shown, the welding-type tool 102 is connected to a welding cable 124 that leads to, and puts the welding-type tool 102 in electrical communication with, the welding-type equipment 106. In some examples, welding-type power (and/or consumables) for the welding arc 118 may be provided to the welding-type tool 102, by the welding equipment 106, via the welding cable 124. In some examples, the welding-type tool 102 may transmit one or more signals to the welding-type equipment 106 when activated (e.g., via the welding cable 124), and the welding-type equipment 106 may provide the welding-type power (and/or consumables) for the arc 118 in response.

In the example of FIG. 1, the welding-type equipment 106 comprises a welding-type power supply 126, wire feeder 128, and gas supply 130. In some examples, the wire feeder 128 may be configured to feed wire to the welding-type tool 102 (e.g., via welding cable 124). In some examples, the gas supply 130 may be configured to route shielding gas to the welding-type tool 102 (e.g., via welding cable 124). In some examples, the power supply 126 may be configured to route welding-type power to the welding-type tool 102 (e.g., via welding cable 124).

In the example of FIG. 1, the power supply 126 includes power communication circuitry 132, power control circuitry 134, and power conversion circuitry 136 interconnected with one another. In some examples, the power supply 126 may communicate with one or more external devices via one or more signals sent or received by the power communication circuitry 132. In some examples, the power conversion circuitry 136 may be configured to receive input power (e.g., from a generator, a battery, mains power, etc.) and convert the input power to welding-type output power, such as might be suitable for use by the welding-type tool 102 for welding-type operations. In some examples, the power control circuitry 134 may be configured to control operation of the power communication circuitry 132 power conversion circuitry 136, wire feeder 128, and/or gas supply 130 (e.g. via one or more control signals) in accordance with one or more welding parameters.

In the example of FIG. 1, the welding-type equipment 106 further includes an operator interface 138. In some examples, the operator interface 138 may comprise one or more display screens, touch screens, knobs, buttons, levers, switches, microphones, speakers, lights, and/or other mechanisms through which an operator 110 may provide input to, and/or receive output from, the welding-type equipment. For example, an operator 110 may use the operator interface 138 to input one or more welding parameters (e.g., target voltage, current, wire feed speed, wire/filler type, wire/filler diameter, gas type, gas flow rate, welding-type process, material type of workpiece 122, position of welding-type process, etc.). As another example, the operator 110 may use the operator interface 138 to view and/or otherwise understand the current welding parameters of the welding-type equipment 106.

While shown as part of the power supply 126 in FIG. 1, in some examples, the operator interface 138, power control circuitry 134, and/or power communication circuitry 132 (and/or some other control/communication circuitry) may be part of the wire feeder 128 and/or gas supply 130. In some examples, the welding-type equipment 106 may be omitted entirely, or may be mock and/or simulated welding-type equipment 106, such as may be used for training, simulated, and/or mock welding-type operations. While not shown for the sake of simplicity, in some examples, the welding-type equipment 106 may also be connected to, and/or provide power to (e.g., via a cable and/or clamp), a welding bench 140, and/or the workpiece(s) 122 supported by the welding bench 140.

In the example of FIG. 1, the welding-type equipment 106 is further shown connected to a computing system 108 having a computing device 142 and several computing user interface (UI) devices 144. In the example of FIG. 1, the computing UI devices 144 include a display screen 146, a keyboard 148, a mouse 150, a stack light 152 with a variety of different (e.g., color, shape, size, etc.) lights that may be illuminated in various ways (e.g., based on one or more received signals), and a vibration device 154 that may provide vibration feedback in various ways/patterns (e.g., based on one or more received signals). The vibration device 154 may be coupled to, for example, the welding torch 102, the welding helmet 104, the operator's clothing or other equipment, and/or any other location where the operator can feel the feedback from the vibration device 154.

In some examples, the computing UI devices 144 may be in (e.g., wired and/or wireless) communication with the computing device 142. In some examples, the display screen 146 may be a touch screen. In some examples, the display screen 146 may include one or more speakers and/or microphones.

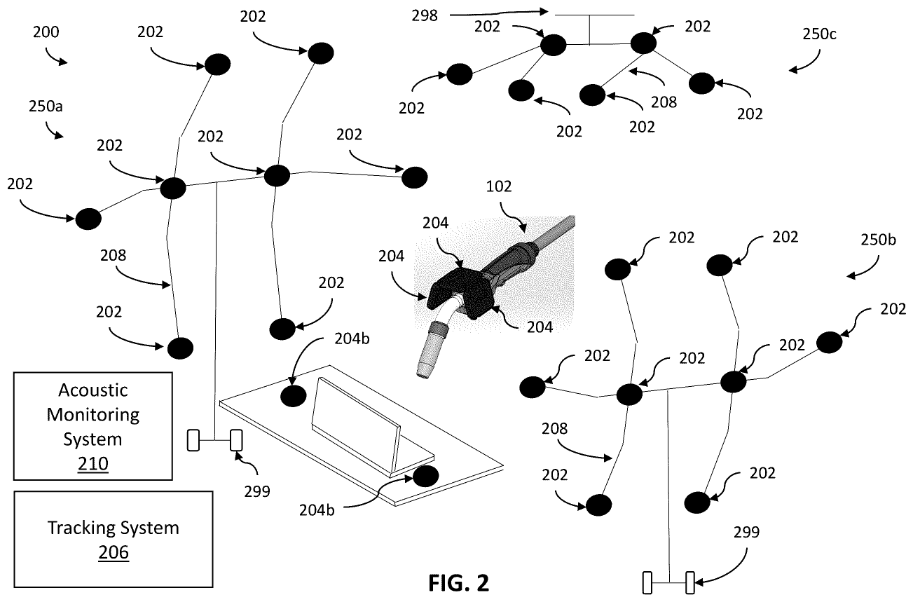

While shown as a desktop computer in the example of FIG. 1, in some examples, the computing device 142 may instead be some other appropriate computational apparatus, such as, for example, a laptop computer, a tablet computer, smart phone, other mobile device, and/or a web server. Though shown as being physically connected to the welding-type equipment 106 via a wire cable, in some examples, the computing device 142 may be in wireless communication with the welding-type equipment 106 (and/or welding helmet 104). While shown as a separate and distinct entity in the example of FIG. 1, in some examples, the computing system 108 may be implemented via the welding-type equipment 106, welding helmet 104, and/or a tracking system 206 (discussed below with respect to FIG. 2).

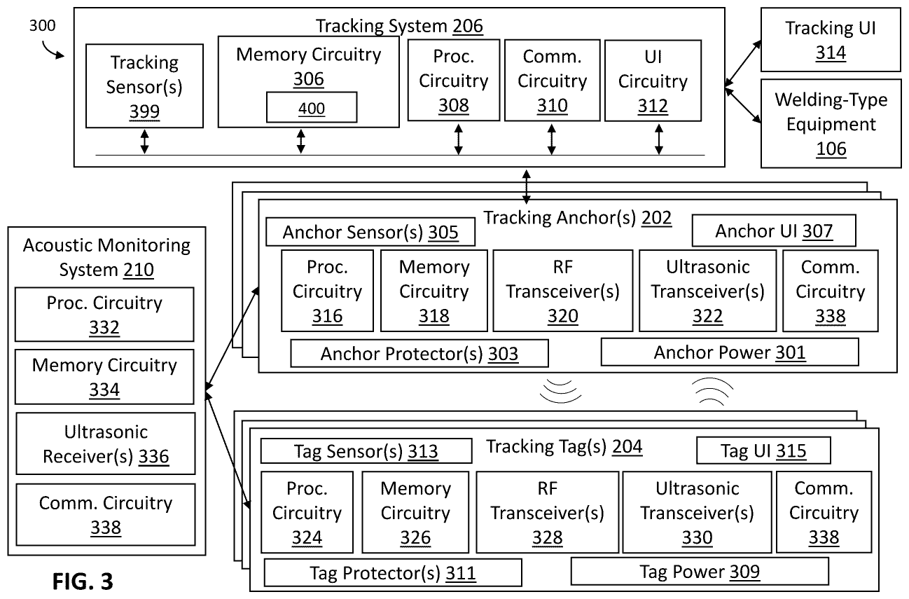

In the example of FIG. 1, tracking anchors 202 are shown around the welding environment, while tracking tags 204 are shown as being attached to some objects (e.g., the welding-type tool 102, welding helmet 104, welding-type equipment 106, workpiece 122, etc.) and/or people (e.g., operators 110). As described in more detail below, the positions/locations and/or orientations of the objects and/or people of the example welding-type system 100 of FIG. 1 may be tracked by a tracking system 206 of a welding technique monitoring system 300 (see, e.g., FIG. 3) using the tracking anchors 202 and/or tracking tags 204. In some examples, the tracking system 206 and/or welding technique monitoring system 300 may track the objects and/or people (e.g., in a welding environment) for the purpose of training, guiding, and/or assessing operators 110 during live and/or simulated welding-type operations.

In some examples, the tracking system 206 and/or welding technique monitoring system 300 may use arrays 250 of tracking anchors 202, arranged in a fixed configuration, to track the three-dimensional (3D) location and/or orientation of (e.g., moving) objects and/or people (see, e.g., FIG. 2). In some examples, the tracking system 206 may track the objects and/or people by tracking tags 204 that are attached to, and/or positioned in/on, the objects and/or people. In some examples, the tracking system 206 may track the tracking tags 204 by analyzing communications between the tracking anchor(s) 202 and tracking tag(s) 204.

In some examples, the tracking anchors 202 and/or tracking tags 204 may be considered part of (and/or encompassing) an indoor positioning system (IPS), such as, for example, an IPS sold by ZeroKey as a spatial intelligence platform. In some examples, the tracking anchors 202 and/or tracking tags 204 may include one or more power sources (wired power source or battery), processors, memories, communication means (Bluetooth, WiFi, Ethernet, etc.), ultrasonic speakers, ultrasonic microphones, RF emitters, RF antennas, accelerometers, gyroscopes, temperature sensors, haptic vibration transducers, switches, LEDs, user interfaces, and other supporting circuitry.

FIG. 2 illustrates an example arrangement 200 of tracking anchors 202 and tracking tags 204. The tracking anchors 202 are shown oriented in different directions to maximize the range of angles for tracking the tracking tags 204. The tracking tags 204 are shown attached to an example object (e.g., the welding torch 102 of FIG. 1).

In the example of FIG. 2, the arrangement 200 further includes a tracking system 206 in communication with the tracking anchors 202 for receiving location data, calibrating/controlling/configuring the tracking anchors 202, and/or determining welding technique parameter values, quality scores, performance scores, and/or other welding-related data based on tracking information and/or any other location-related activities. The example arrangement 200 additionally includes an acoustic monitoring system 210 that monitors the area proximate the tracking anchors 202 and/or the tracking tags 204 for excess or interfering levels of ultrasonic noise and provides feedback to enable the tracking anchors 202 and/or the tracking tags 204 to avoid frequencies at which excess or interfering levels of noise are present.

In the example of FIG. 2, three arrays 250 of tracking anchors 202 are shown. In some examples, multiple arrays 250 of fixed tracking anchors 202 may be used to enlarge the volume for tracking. As shown, each array 250 includes plurality of tracking anchors 202 rigidly attached to each other via structural supports.

In the example of FIG. 2, arrays 250a and 250b are shown mounted on wheels 299 and/or casters for easy transport. In this way, the arrays 250a and 250b can each be moved around easily to ensure proper tracking of the welding activity. Array 250c is shown fixedly mounted to the ceiling 298. While the array 250c is shown attached to a ceiling 298, in some examples, the array 250c (and/or other arrays 250) may instead be attached to different stationary structures within the environment, such as, for example, the welding bench 140, walls, floors, beams, pillars, etc. In some examples, each array 250 of anchors 202 may share a common power source and/or a communication hub.

In some examples, the tracking system 206 may be pre-calibrated with the positions of each anchor 202 in each array 250 so that the precise relative 3D position of each anchor 202 and/or each array 250 is known by the tracking system 206 (e.g., absolutely and/or with respect to other anchors 202, other arrays 250, particular tracking tags 204, a workpiece 122, and/or other reference points/frames). In some examples, the portable arrays 250a and 250b may be calibrated such that they may be moved as a single structure without having to recalibrate the relative spatial arrangement of the anchors 202 every time they are moved around. In some examples, the tracking system 206 may periodically, or in response to movement and/or a request, determine (and/or re-determine/recalibrate) the positions of the tracking anchors 202 and/or arrays 250 with respect to one or more reference locations. In some examples, an array 250 of anchors 202 may be reset and/or recalibrated with respect to one or more reference points to allow for tracking of objects with respect to another object of interest (e.g., a workpiece 122, a welding table/bench 140, a welding fixture, etc.).

In the example of FIG. 2, the welding-type tool 102 has three tracking tags 204 attached around a neck of the tool 102 in a fixed rigid configuration. In some examples, tracking tags 204 may instead be mounted to the (e.g., rear portion of the) handle of the tool 102 (see, e.g., FIG. 1). Tracking tags 204 may also be mounted to a flange extending off the handle to reduce the likelihood of being blocked by the hands and/or gloves of the operator 110.

In some examples, multiple tags 204 may be mounted to the tool 102 to maximize the likelihood of being tracked by the surrounding anchors 202. These tags 204 may also be configured as a rigid body. Tracking tags 204 may be mounted and/or configured at different angles and/or different positions on the tool 102 to further maximize the likelihood of being tracked by the surrounding anchors 202. The tags 204 may be powered by wires embedded into the welding cable 124 or handle, battery-powered, or powered by a separate cable.

While shown as having three tracking tags 204 in the example of FIG. 2, in some examples, the tool 102 (or other object/person) may instead have one, two, four, five, six, and/or more tracking tags 204 attached. In some examples, the tracking tag(s) 204 are attached in a predetermined (e.g., stored in memory) position and orientation with respect to the welding-type tool 102 (or other object/person).

After the tracking tags 204 are rigidly attached to the welding tool 102, their position/orientation relative to each other and/or relative to the tip of the tool 102 are calibrated. Calibration allows the position/orientation of the tip of the welding tool 102 to be calculated based on the tracked position/orientation of the tracking tags 204.

Though shown as being attached to a tool 102 in the example of FIG. 2, in some examples, the tags 204 may be attached to a different object and/or person. For example, tracking tags 204 may be placed on the glove or wristband of the weld operator 110 to track the user's hand. Tracking tags 204 may be attached to objects and/or people via straps, brackets, adhesive, fasteners, or other means.

A separate calibration procedure may be used to determine the position/orientation of the tip of the welding tool 102 relative to the tracking tags 204 on the glove. The location and/or orientation of the workpiece 122 may also be calibrated by, for example, touching the workpiece 122 and/or joint 120 using a tracking tag 204 (e.g., a tracking tag 204 dedicated for marking the workpiece 122), the welding tool 102, or another dedicated calibration device, to determine the position/orientation of the workpiece relative to the tracking anchors 202.

In an example tracking scheme, each interrogating anchor 202 emits an RF trigger signal encoded with information on the source (i.e. an anchor ID number). The RF trigger signal may be received by a tracking tag 204. The tracking tag 204, in response, emits an ultrasonic signal. Alternatively, or additionally, the tracking anchor 202 may transmit the ultrasonic response signal(s) at approximately the same time as (or immediately after) transmitting the RF trigger signal.

One triggering RF signal from one of the tracking anchors 202 may provoke multiple response signals in the presence of multiple tracking tags 204. The response signal may include data such as an identifier of the responding/receiving tracking tag 204 and/or an identifier of the tracking anchor 202 that generated the trigger signal (e.g., to which the response signal is responding). The interrogating anchor 202 (and/or a tag 204) receives the responding ultrasonic signal, and the total time delay between the sending and receiving of the signals is determined (e.g., by the anchor 202, the tag 204, and/or the tracking system 206).

Since the RF signal travels at the speed of light and the ultrasonic signal travels at the speed of sound in ambient air (which is significantly slower than light speed), the time delay is almost entirely dependent on the distance between the anchor 202 and tracking tag 204. As such, the distance between the tracking anchor 202 and the tracking tag 204 can be calculated based on the time delay between the sending and receiving of the signals (e.g., the time between transmitting/receiving the triggering signal and receiving the response signal), and the speed of sound in ambient air. By determining distances between the tracking tag 204 and three or more tracking anchors 202 having predetermined positions, a tracking system 206 can measure the three-dimensional position of the tracking tag 204.

In another example tracking scheme, an interrogating anchor 202 emits an ultrasonic trigger signal encoded with information on the source (i.e. an anchor ID number), as well as the time the signal was sent. The tracking tag 204 receives the signal, and records the time the signal was received. The time delay between transmission and reception and the speed of sound in ambient air may be used to determine the distance(s) between anchor(s) 202 and tag(s) 204.

In some examples, the ultrasonic signals are emitted from the tracking anchor 202 and/or tracking tag 204 with a cone angle of about 120 degrees. In cases in which the tracking anchor 202 must be in line-of-sight of the emission cone of the tag 204 to receive the ultrasonic signal, the array of tracking anchors 202 is preferably positioned to ensure that three or more of them have line-of-sight to each tracking tag 204 within the expected range of motion of the tracking tags 204, while also accounting for possible obstructions to line-of-sight such as the body of the operator 110 or workpiece 122 being welded.

In some examples, a temperature sensor may also be used to compensate for variations in the speed of sound related to ambient temperature. The temperature sensor may be integrated into the tracking anchor 202 and/or tracking tag 202, or may be located elsewhere (e.g., as part of the tracking system 206) to ensure an accurate measurement of the ambient air temperature.

Using three or more anchors 202, each determining the distance to a single tracking tag 204, the three-dimensional position of the tracking tag 204 can be determined relative to the array of anchors 202 via triangulation and/or other algorithms. With multiple tracking tags 204 attached to a single object, the position and/or orientation of the object can be determined. Three or more tracking tags 204, spatially separated in a fixed rigid configuration, can be defined as a rigid body and used for six-degree-of-freedom (6DOF) tracking (see, e.g., the tags 204 attached to the welding-type tool 102 in FIGS. 1 & 2). Using an accelerometer internal to the tracking tags 204 to measure the angle of each tracking tag 204 relative to gravity, some examples achieve 6DOF tracking using only two spatially separated tracking tags 204 rigidly connected to each other and to the object. By using an accelerometer and/or gyroscope internal to a tracking tag 204 to measure the angular orientation (e.g., yaw, pitch, and roll) of the tracking tag, some examples achieve 6DOF tracking using only a single tracking tag 204.

Thus, by determining distances between the tracking tag(s) 204 on the tool 102 and the anchor(s) 202, positions of the tracking tags 204 may be determined (e.g., using known/calibrated locations of the plurality of tracking anchors 202). And using the positions of each of the tracking tags 204 attached to the tool 102 (e.g., relative to the tracking anchor(s) 202 and/or a reference point/frame), the position and orientation of the tool 102 can be determined (e.g., using a stored rigid body model representing the predetermined positions and orientations of the tracking tag(s) 204 with respect to the welding tool 102 and/or a triangulation technique).

In some examples, the tracking system 206 determines positions of the plurality of tracking anchors 202 by a reverse triangulation, such as by determining the positions of two or more reference tracking tags 204b using three or more of the tracking anchors 202. For example, sets of the tracking anchors 202 may be arranged in a predetermined spatial relationship (e.g., on a rigid structure 208). By using three or more of the tracking anchors 202 in the predetermined spatial relationship (e.g., on the rigid structure 208) to determine the locations of two or more reference tracking tags 204b, the tracking system 206 can determine the locations of each of the tracking anchors 202 in the same predetermined spatial relationship (e.g., on the same rigid structure 208) with respect to the reference tags 204b and/or with respect to a reference frame defined using the reference tags 204b.

With the welding-type tool 102 tracked and the workpiece 122 calibrated, the tracking system 206 can determine the position and/or orientation of the welding tool tip relative to the workpiece 122 and/or joint 120, and calculate welding technique parameters (e.g., work angle, travel angle, contact tip to work distance, aim, travel speed, travel direction, push/pull, weaving parameters, etc.). Example techniques for calculating and displaying welding technique parameters are described in U.S. Pat. No. 10,427,239, to William Becker. The entirety of U.S. Pat. No. 10,427,239 is incorporated herein by reference. In some examples, performance scores, quality scores, and/or other information may also be determined.

In some examples, the system 300 detects when welding occurs to initiate recording of data associated with the welding technique, and/or feedback with respect thereto. For simulated welding sessions, a user input (e.g., via a trigger of the tool 102 or a user interface) may be provided to determine the beginning and end of a simulated weld.

In some examples, the tracking system 206 may have a tracking user interface (UI) 314 (e.g., comprising displays, speakers, haptics, etc.) to provide (e.g., technique, score, quality, etc.) feedback and information to the user (see, e.g., FIG. 3). In some examples, the tracking UI 314 may additionally have one or more input devise (e.g., buttons, levers, touch screens, microphones, etc.) to receive input from the user. In some examples, each tracking tag 204 may additionally have a tag UI 315 (e.g., comprising displays, speakers, haptics, etc.) to provide (e.g., technique) feedback and information to the user. In some examples, a welding helmet 104 and/or glasses (e.g., safety glasses) may contain a display screen 112 capable of overlaying information related to welding technique (visual guides, numerical values, etc.).

In some examples, one or more tracking tags 204 may also be attached to the welding helmet 104 and/or glasses and used to facilitate tracking relative to the workpiece 122, welding tool 102, tracking anchors 202, etc. In some examples, tracking of the helmet 104 and/or glasses would allow the information displayed to be rendered to spatially correlate with the objects being viewed through the helmet or glasses (i.e. travel speed guide overlaid on the welding joint 120, angle guides overlaid adjacent to the welding tool 102, etc.). Example techniques for displaying welding information are described in U.S. Pat. No. 10,380,911, to Hsu et al., U.S. Pat. No. 10,448,692, to Hsu et al., U.S. Pat. No. 11,322,041, to Sommers et al., and U.S. Pat. No. 10,406,638, to Albrecht et al. The entireties of U.S. Pat. Nos. 10,380,911, 10,448,692, 11,322,041, and 10,406,638 are incorporated herein by reference.

In some examples, the tracking anchors 202 and/or tracking tags 204 may have a replaceable protective cover to protect from welding spatter, dust, debris, and/or other particulate in the air or environment. The cover may be a thin plastic cover, or a very thin film-like sheet to minimize the attenuation of the ultrasonic signal. Additionally or alternatively, an air knife may be used to protect the tracking anchors 202 and tracking tags by blowing ambient air or other gas across the surface of the device to protect the device from particulate. In addition, the tracking anchors 202 and/or tracking tags 204 may include means for cooling (i.e. blowing air, conducting flowing water) to prevent overheating in the welding environment.

Example implementations of the tracking anchors 202 and/or tracking tags 204, and/or calculation of the locations of tags 204, are described in International Patent Application No. PCT/CA2021/050338, filed Mar. 12, 2021, by Lowe et al., U.S. Pat. No. 10,051,599 to Lowe et al., U.S. Pat. No. 10,627,479 to Lowe et al., and/or “The Cricket Location-Support System” by Nissanka B. Priyantha et al., MIT Laboratory for Computer Science, 6th ACM International Conference on Mobile Computing and Networking (ACM MOBICOM), Boston, MA, August 2000 (also available at http://nms.lcs.mit.edu/papers/cricket.pdf). Each of International Patent Application No. PCT/CA2021/050338, U.S. Pat. Nos. 10,051,599, 10,627,479, and “The Cricket Location-Support System” are incorporated by reference herein.

Live welding naturally emits ultrasonic sound and RF radiation, with different spectrums being emitted by different welding processes (MIG, TIG, Stick, Pulsed MIG, Pulsed TIG, TIG with HF start) and/or welding settings (voltage, amperage, inductance, pulse waveform/frequency, wire feed speed, gas composition/flow, wire type, material type, etc.). Because example tracking systems 206 and/or monitoring systems 300 described herein rely on the accurate detection of ultrasonic and RF signals, there is a possibility of interference to tracking due to welding.

To maintain tracking accuracy in the presence of potential interference, example arrangements 200 and/or systems 300 include an acoustic monitoring system 210 comprising broadband ultrasonic receivers 336 (e.g., comprising antennas and/or associated circuitry) and/or RF circuitry 338 (e.g., comprising RF antennas). In some examples, the acoustic monitoring system 210 may be placed in proximity to a welding environment, the tracking anchors 202, and/or the tracking tags 204 to automatically detect the natural welding emission bandwidths/spectrums.

In some examples, the tracking system 206, the tracking anchors 202, and/or the tracking tags 204 are controlled to avoid electromagnetic and/or acoustic interference generated by a live welding process, to permit effective use of the location and orientation tracking during live (e.g., arc-on) welding. For example, the tracking anchors 202 and/or tracking tags 204 may be configured to transmit the response signals using ultrasonic frequencies selected to avoid interference from welding-based noise. The tracking system 206, the tracking anchors 202, and/or the tracking tags 204 may be in communication with the acoustic monitoring system 210 to enable the tracking anchors 202 and/or the tracking tags 204 to avoid frequencies at which excess or interfering levels of noise are present.

The signals used by the anchors 202, tags 204, tracking system 206, and/or monitoring system 300 may be automatically selected or customized to avoid interference with the detected emissions (e.g., using a spectrum, channel, or frequency with the least amount of detected emissions). For example, the acoustic monitoring system 210 may transmit feedback representative of preferred ultrasonic channels and/or frequencies and/or non-preferred ultrasonic channels and/or frequencies. The tracking anchors 202 may then encode the preferred and/or non-preferred channels and/or frequencies in the triggering signals. The tracking system 206, tracking tags 204, and/or tracking anchors 202 use the channel information to select channels and/or frequencies for transmitting the response signals, thereby avoiding interference. Additionally or alternatively, the tracking tags 204 may receive the feedback from the acoustic monitoring system 210 and select an ultrasonic channel to transmit the response signals based on the feedback.

In some examples, the tracking system 206 may determine the proper ultrasonic and RF signal frequencies to use based on the welding parameters/process being used. The welding parameters/process may be known via user input or automatically detected (i.e. via communication with the welding equipment 106). The welding parameters and/or welding process may be communicated to the tracking system 206, the tracking anchors 202, and/or the tracking tags 204 from the welding equipment 106 (e.g., the power supply 126, the wire feeder 128, etc.).

In some examples, the tracking tags 204 select an ultrasonic channel to transmit the response signals based on a (e.g., stored) table having ultrasonic frequency data associated with welding parameters and/or welding processes used to perform the welding operation. In other examples, the tracking anchors 202 determine, based on a table having ultrasonic frequency data associated with welding parameters and/or welding processes used to perform the welding operation, preferred ultrasonic channels and/or frequencies and/or non-preferred ultrasonic channels and/or frequencies. The emissions spectrums from common welding processes may be determined and/or input into the system 300 (e.g., user customization, embedded within the software, etc.). The tracking anchors 202 may then transmit the triggering signal having data representative of the preferred ultrasonic channels and/or frequencies and/or non-preferred ultrasonic channels and/or frequencies, and the tracking tags 204 may select the ultrasonic channel to transmit the response signals based on the data in the triggering signals. As another alternative, the tracking system 206 may automatically hop to different frequencies if interference is detected or tracking is lost.

FIG. 3 is a block diagram showing an example welding technique monitoring system 300. As shown, the welding technique monitoring system 300 includes the tracking system 206, multiple tracking anchors 202, multiple tracking tags 204, the acoustic monitoring system 210, a tracking UI 314, and the welding-type equipment 106. While shown as a separate processing system in the example of FIG. 3, in some examples, some or all of the tracking system 206 and/or acoustic monitoring system 210 may be implemented by the tracking anchor(s) 202, the tracking tag(s) 204, the welding helmet 104, the computing device 142, and/or the welding-type equipment 106.

In the example of FIG. 3, the tracking system 206 includes tracking memory circuitry 306, tracking processing circuitry 308, tracking communication circuitry 310, tracking UI circuitry 312, and tracking sensors 399 interconnected with one another via a common electrical bus. In some examples, the tracking sensors 399 may include one or more temperature sensors. In the example of FIG. 3, the welding technique monitoring system 300 also includes a tracking UI 314 in communication with tracking system 206. In some examples, the tracking UI 314 may be implemented by the computing UI devices 144, helmet UI devices 114, and/or operator interface 138 of the welding-type equipment 106.

In the example of FIG. 3, the example tracking anchors 202 include anchor processing circuitry 316, anchor memory circuitry 318, an anchor RF transceiver 320, and an anchor ultrasonic transceiver 322. The example anchor processing circuitry 316 executes machine readable instructions, which may be stored on the anchor memory circuitry 318. The anchor RF transceiver 320 transmits an RF trigger signal, which may include data to identify the transmitting tracking anchor 202 and/or have a specific frequency to accommodate noise present in a welding environment. The anchor ultrasonic transceiver 322 is configured to transmit, receive, and/or decode ultrasonic signals (e.g., from one or more tracking tags 204).

In some examples, the anchor processing circuitry 316 processes the data received via the anchor ultrasonic transceiver 322, determines a time between transmission of a trigger signal and receipt of a responsive response signal, and determines a distance to the tracking tag 204 from which the response signal is received. The anchor processing circuitry 316 and/or the anchor ultrasonic transceiver 322 may discard or ignore ultrasonic signals which do not correspond to trigger signals sent by that tracking anchor 202.

In the example of FIG. 3, the tracking anchor 202 further includes an anchor power source 301, one or more anchor protectors 303, one or more anchor sensors 305, and an anchor UI 307. In some examples, the anchor power source 301 may be a dedicated power supply, a power bus connected to an array 250 of tracking anchors 202 (e.g., anchors connected to a same structure 208), and/or some other source. In some examples, the anchor protectors 303 may include one or more replaceable protective covers, air knives, and/or cooling devices, as discussed above. In some examples, the anchor sensors 305 may include accelerometers, gyroscopes, magnetometers, and/or temperature sensors, as discussed above. In some examples, the anchor UI 307 may include one or more input and/or output devices, such as, for example, (e.g., touch screen) displays, microphones, speakers, haptics, buttons, knobs, slides, levers, etc.

In the example of FIG. 3, each tracking tag 204 includes tag processing circuitry 324, tag memory circuitry 326, a tag RF transceiver 328, and a tag ultrasonic transmitter 330. The example tag processing circuitry 324 executes machine readable instructions, which may be stored on the tag memory circuitry 326. The tag RF transceiver 328 receives RF trigger signals, which may include data to identify the transmitting tracking anchor 202. In response to the trigger signal, the tag processing circuitry 324 controls the tag ultrasonic transmitter 330 to transmit an ultrasonic signal including the identifier of the tracking anchor (or identifier of the trigger message) to which the ultrasonic response signal is responding, and an identifier of the tracking tag 204 which is responding.

In the example of FIG. 3, each tag 204 further includes a tag power source 309, one or more tag protectors 311, one or more tag sensors 313, and a tag UI 315. In some examples, the tag power source 309 may be a dedicated power supply and/or a battery, and/or may be a connection to an external power supply of an object to which the tag 204 is attached (e.g., welding-type circuit of welding-type equipment 106, tool 102, etc.). In some examples, the tag protectors 311 may include one or more replaceable protective covers, air knives, and/or cooling devices, as discussed above. In some examples, the tag sensors 313 may include accelerometers, gyroscopes, magnetometers, and/or temperature sensors, as discussed above. In some examples, the tag UI 315 may include one or more input and/or output devices, such as, for example, (e.g., touch screen) displays, microphones, speakers, haptics, buttons, knobs, slides, levers, etc.

In the example of FIG. 3, the system 300 further includes the acoustic monitoring system 210. As shown, acoustic monitoring system 210 includes acoustic processing circuitry 332, acoustic memory circuitry 334, and an acoustic ultrasonic receiver 336 (or transceiver). The example acoustic processing circuitry 332 measures and analyzes the frequency distribution of ultrasonic noise in the environment proximate the tracking anchors 202 and the tracking tags 204, and/or determines one or more preferred frequencies and/or channels, and/or one or more non-preferred frequencies and/or channels. The acoustic processing circuitry 324 may use these preferred frequencies and/or channels, and/or one or more non-preferred frequencies and/or channels to select an ultrasonic channel or frequency for transmitting response signals.

In the example of FIG. 3, the example tracking anchors 202, tracking tags 204, and/or acoustic monitoring system 210 further include respective communication circuitry 338 to enable wired and/or wireless communications between the tracking anchors 202, the tracking tags 204, the acoustic monitoring system 210, the tracking system 206, and/or the welding-type equipment 106.

In some examples, the tracking communication circuitry 310 and/or communication circuitry 338 may include one or more wireless adapters, wireless cards, cable adapters, wire adapters, dongles, radio frequency (RF) devices, wireless communication devices, Bluetooth devices, IEEE 802.11-compliant devices, WiFi devices, cellular devices, GPS devices, Ethernet ports, network ports, lightning cable ports, cable ports, etc. In some examples, the tracking communication circuitry 310 and/or communication circuitry 328 may be configured to facilitate communication via one or more wired media and/or protocols (e.g., Ethernet cable(s), universal serial bus cable(s), etc.) and/or wireless mediums and/or protocols (e.g., cellular communication, general packet radio service (GPRS), near field communication (NFC), ultra high frequency radio waves (commonly known as Bluetooth), IEEE 802.11x, Zigbee, HART, LTE, Z-Wave, WirelessHD, WiGig, etc.). In some examples, the tracking communication circuitry 310 and/or communication circuitry 328 may be coupled to one or more antennas to facilitate wireless communication.

In some examples, the tracking communication circuitry 310 and/or communication circuitry 328 may be configured to facilitate internal and/or external communications. In some examples, the tracking communication circuitry 310 and/or communication circuitry 328 may receive one or more signals (e.g., from each other and/or the welding-type equipment 106) decode the signal(s), and provide the decoded data to other components (e.g., directly, via a communications bus). As another example, the tracking communication circuitry 310 and/or communication circuitry 328 may receive one or more signals from the communications bus (e.g., representative of one or more inputs received via the tracking UI circuitry 312) encode the signal(s), and transmit the encoded signal(s) to an external device.

In some examples, the tracking processing circuitry 308, anchor processing circuitry 316, tag processing circuitry 324, and/or acoustic processing circuitry 332 include one or more processors, controllers, and/or graphical processing units (GPUs). In some examples, the tracking processing circuitry 308, anchor processing circuitry 316, tag processing circuitry 324, and/or acoustic processing circuitry 332 may include counter circuitry and/or clock circuitry. In some examples, the tracking processing circuitry 308, anchor processing circuitry 316, tag processing circuitry 324, and/or acoustic processing circuitry 332 may be configured to execute machine readable instructions stored in corresponding memory circuitry 306, 318, 326, 334.

While not shown in the example of FIG. 3, in some examples, the tracking memory circuitry 306 may also include (and/or store) machine readable instructions comprising counter and/or clock programs. In some examples, the tracking memory circuitry 306 may also include (and/or store) values for one or more determined, target, present, and/or past parameters, such as, for example, welding parameters (e.g., voltage, current, wire feed speed, gas flow rate, etc.), welding technique parameters (e.g., work angle, travel angle, travel speed, travel direction, etc.), weave parameters (e.g., frequency, weave width, dwell time, etc.), sensor parameters (e.g., sensor orientation reference frame, tool orientation vector, etc.), joint parameters (e.g., joint orientation vector, base plate perpendicular vector, base plate surface vector, etc.), and/or operation parameters (e.g., job type/identifier(s), operator identifier(s), weld cell identifier(s), project identifier(s), welding procedure specification (WPS) information, work order information, equipment type/identifier(s), weld number information, etc.). In some examples, one or more parameters may be associated with timestamp information, one or more other parameters, and/or other information.

In the example of FIG. 3, the tracking memory circuitry 306 is also shown as including (and/or storing) a monitoring process 400. In some examples, the monitoring process 400 may comprise machine readable instructions configured for execution by the tracking processing circuitry 308. In some examples, the monitoring process 400 may be implemented via discrete circuitry (e.g., of the tracking processing circuitry 308) rather than, or in addition to, being part of (and/or stored in) the tracking memory circuitry 306.

While some of the disclosure below discusses the monitoring process 400 performing certain actions, this should be understood as a shorthand for one or more components of the monitoring system 300 performing the action(s) as part of the monitoring process 400. In some examples, the monitoring process 400 may determine a position and/or orientation of one or more objects as discussed above, identify technique parameters, scores, and/or other information based on the position(s)/orientation(s), and/or provide feedback related thereto.

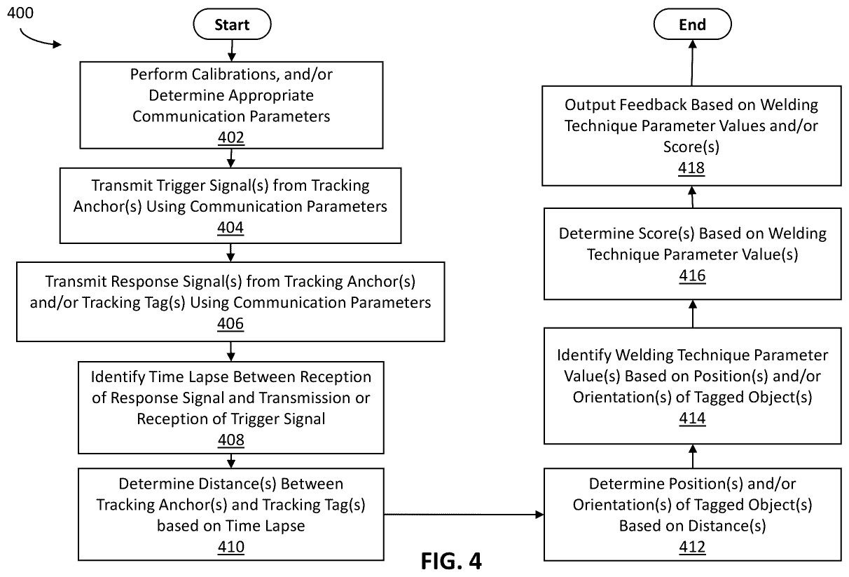

FIG. 4 is a flowchart illustrating an example operation of the monitoring process 400. As shown, the monitoring process 400 begins at block 402, where the monitoring process 400 performs one or more calibrations, and/or determines appropriate communication parameters (e.g., frequency, spectrum, etc.), as discussed above. Next, at block 404, one or more trigger signals are transmitted from one or more tracking anchors 202 (and/or tracking tags 204) using the appropriate communication parameters, as discussed above. At block 406, one or more response signals are transmitted from one or more tracking anchors 202 and/or tracking tags 204 using the appropriate communication parameters, as discussed above.

At block 408, the monitoring process 400 identifies a time difference between reception of the response signal and transmission/reception of the trigger signal, as discussed above. At block 410, the monitoring process 400 determines one or more distances between the tracking anchor(s) 202 and tracking tag(s) 204 based on the time difference(s), as discussed above. Next, at block 412, the monitoring process 400 determines the position(s) and/or orientation(s) of the tagged/tracked object(s) is made based on the time difference(s), as discussed above.

In the example of FIG. 4, the monitoring process 400 determines values corresponding to one or more welding technique parameters based on the position(s) and/or orientation(s) of the tagged/tracked object(s) at block 414, as discussed above. At block 416, the monitoring process 400 determines one or more scores and/or other information based on the welding technique parameter values, as discussed above. Finally, at block 418, the monitoring process 400 provides feedback relating to the welding technique parameter values, scores, and/or other information of the monitoring process 400, as discussed above.

The present methods and/or systems may be realized in hardware, software, or a combination of hardware and software. The present methods and/or systems may be realized in a centralized fashion in at least one computing system, or in a distributed fashion where different elements are spread across several interconnected computing or cloud systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, a control circuit may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor.

The term “power” is used throughout this specification for convenience, but also includes related measures such as energy, current, voltage, and enthalpy. For example, controlling “power” may involve controlling voltage, current, energy, and/or enthalpy, and/or controlling based on “power” may involve controlling based on voltage, current, energy, and/or enthalpy.

As used herein, welding-type refers to actual live, and/or simulated, welding (including laser welding and/or hot wire welding), cladding (including laser cladding), brazing, plasma cutting, induction heating, carbon arc cutting or gouging, hot wire preheating, and/or resistive preheating.

As used herein, a welding-type tool refers to a tool suitable for and/or capable of actual live, and/or simulated, welding (including laser welding and/or hot wire welding), cladding (including laser cladding), brazing, plasma cutting, induction heating, carbon arc cutting or gouging, hot wire preheating, and/or resistive preheating.

As used herein, welding-type power refers to power suitable for actual live welding (including laser welding and/or hot wire welding), cladding (including laser cladding), brazing, plasma cutting, induction heating, carbon arc cutting or gouging, hot wire preheating, and/or resistive preheating.

As used herein, a welding-type power supply and/or welding-type power source refers to a device capable of, when input power is applied thereto, supplying output power suitable for actual live welding (including laser welding and/or hot wire welding), cladding (including laser cladding), brazing, plasma cutting, induction heating, carbon arc cutting or gouging, hot wire preheating, and/or resistive preheating; including but not limited to transformer-rectifiers, inverters, converters, resonant power supplies, quasi-resonant power supplies, switch-mode power supplies, etc., as well as control circuitry and other ancillary circuitry associated therewith.

As used herein, disable may mean deactivate, incapacitate, and/or make inoperative. As used herein, enable may mean activate and/or make operational.

Disabling of circuitry, actuators, and/or other hardware may be done via hardware, software (including firmware), or a combination of hardware and software, and may include physical disconnection, de-energization, and/or a software control that restricts commands from being implemented to activate the circuitry, actuators, and/or other hardware. Similarly, enabling of circuitry, actuators, and/or other hardware may be done via hardware, software (including firmware), or a combination of hardware and software, using the same mechanisms used for disabling.

What is claimed is:

1. A weld tracking system, comprising:
a plurality of tracking anchors, each of the tracking anchors configured to:
transmit a triggering signal, and
transmit a response signal, or receive the response signal from a tracking tag;
a welding device having the tracking tag attached to the welding device, the tracking tag configured to receive the triggering signal and receive the response signal, or receive the triggering signal and transmit the response signal in response to receiving the triggering signal; and
a processing system configured to:
determine distances between each of the tracking anchors and the tracking tag based on a time between the response signal being received and the triggering signal being sent or received, and
determine a location of the welding device based on predetermined locations of the plurality of tracking anchors, and based on determined distances between the tracking tag on the welding device and corresponding ones of the plurality of tracking anchors.

2. The weld tracking system as defined in claim 1, wherein the processing system is configured to determine positions of the plurality of tracking anchors based on a predetermined spatial relationship between the plurality of tracking anchors and based on a calibration process to determine positions of two or more of the plurality of tracking anchors in the predetermined spatial relationship with respect to a reference location.

3. The weld tracking system as defined in claim 1, wherein the welding device is at least one of a welding torch, a welding helmet, safety glasses, or a welding fixture.

4. The weld tracking system as defined in claim 1, wherein the processing system is configured to determine the location of the welding device with respect to the reference location based on the positions of the plurality of tracking anchors.

5. The weld tracking system as defined in claim 1, wherein the triggering signal is an electromagnetic signal and the response signal is an acoustic signal.

6. The weld tracking system as defined in claim 5, wherein the triggering signal is a radio frequency signal.

7. The weld tracking system as defined in claim 5, wherein the triggering signal is an ultrasonic signal.

8. The weld tracking system as defined in claim 1, wherein the welding device has a plurality of tracking tags attached to the welding device, and the processing system is configured to determine the location of the welding device based on measuring the locations of the plurality of tracking tags.

9. The weld tracking system as defined in claim 8, wherein the processing system is configured to determine an orientation of the welding device based on measuring the locations of the plurality of tracking tags on the welding device and based on a rigid body model of the welding device and the plurality of tracking tags on the welding device.

10. The weld tracking system as defined in claim 1, wherein the welding device is a welding torch, and the processing system is configured to determine a welding performance based on a plurality of locations of the welding device during a welding operation.

11. The weld tracking system as defined in claim 1, wherein the tracking tag or each of the tracking anchors is configured to transmit the response signal as an ultrasonic signal having a frequency selected to avoid interference from welding-based noise.

12. The weld tracking system as defined in claim 11, further comprising a noise monitor configured to measure ultrasonic frequencies in an environment proximate to the tracking anchors and the tracking tag, and configured to transmit feedback representative of at least one of a preferred ultrasonic channel or ultrasonic frequency or a non-preferred ultrasonic channel or ultrasonic frequency.

13. The weld tracking system as defined in claim 12, wherein the plurality of tracking anchors are configured to transmit the triggering signal having data representative of the at least one of a preferred ultrasonic channel or ultrasonic frequency or a non-preferred ultrasonic channel or ultrasonic frequency, and the tracking tag is configured to select an ultrasonic channel to transmit the response signal based on the data in the triggering signal.

14. The weld tracking system as defined in claim 12, wherein the tracking tag or each of the tracking anchors is configured to receive the feedback from the noise monitor and select an ultrasonic channel to transmit the response signal based on the feedback.

15. The weld tracking system as defined in claim 11, wherein the tracking tag or each of the tracking anchors is configured to select an ultrasonic channel to transmit the response signal based on a table having ultrasonic frequency data associated with at least one of a welding parameter or a welding process.

16. The weld tracking system as defined in claim 11, wherein the plurality of tracking anchors are configured to:
determine, based on a table having ultrasonic frequency data associated with at least one of a welding parameter or a welding process, at least one of a preferred ultrasonic channel or ultrasonic frequency or a non-preferred ultrasonic channel or ultrasonic frequency; and
transmit the triggering signal having data representative of the at least one of a preferred ultrasonic channel or ultrasonic frequency or a non-preferred ultrasonic channel or ultrasonic frequency, and the tracking tag is configured to select an ultrasonic channel to transmit the response signal based on the data in the triggering signal.

17. The weld tracking system as defined in claim 1, wherein the welding device comprises:
three or more tracking tags spatially separated in a fixed rigid configuration;
two spatially separated tracking tags rigidly connected to each other, each of the tracking tags comprising an accelerometer configured to measure the angle of the tracking tag relative to gravity; or
a single tracking tag having an accelerometer and a gyroscope,
wherein the processing system is configured to determine a six-degree-of-freedom location and orientation of the welding device based on the three or more tracking tags, the two tracking tags, or the one tracking tag.

18. The weld tracking system as defined in claim 1, wherein the plurality of tracking anchors are affixed to one or more rigid structures defining a rigid spatial relationship between the ones of the tracking anchors affixed to the respective rigid structure.

19. The weld tracking system as defined in claim 18, wherein the rigid structures are portable.

20. The weld tracking system as defined in claim 1, wherein the processing system is configured to determine, based on the location of the welding device and a rigid body model of the tracking tag and the welding device, at least one of a work angle, a travel angle, a travel direction, a travel speed, or a contact tip to work distance of a welding torch during a live welding operation or a simulated welding operation.
